(19) United States
(12) Patent Application Publication
(10) Pub. No.: US 2014/0188994 A1
(43) Pub. Date: Jul. 3, 2014

(54) Social Neighborhood Determination

(71) Applicant: David Patterson, Berkeley, CA (US)

(72) Inventor: David Patterson, Berkeley, CA (US)

(73) Assignee: Wal-Mart Stores, Inc., Bentonville, AR (US)

(21) Appl. No.: 13/730,376

(22) Filed: Dec. 28, 2012

(51) Int. Cl. H04L 29/06

(52) U.S. Cl. CPC H04L 29/06
USPC 709/204

(57) ABSTRACT

The present disclosure extends to methods, systems, and computer program products for determining, by a social neighborhood server, a social neighborhood of a user. In operation, user information is received that is related to social network connections to other users within the user's social network. Using this information, information is presented to the user related to social network connections attributable to the user based on the received user information, which may include user network connections of the user. Then, the user is invited to assign information related to user influence that the user attributes to individual social network connections presented to the user. In other implementations, social network entities, whether they be for example users or commercial interests, may be presented to a user that are not within the user's social network. The information related to the user influence is then received, and an influence metric is assigned to the individual social network connections according to the user's input.

### BACKGROUND

In the world of social media, social networks are made up of users that communicate with and receive communications from other users. As a consequence, a great deal of information on user behavior now exists and is ever expanding. This information is hotly desired by businesses and data mining entities that wish to exploit this information. It is a very sensitive area, because users desire to conduct themselves in their own social media networking circles in a manner that gives them ever expansive options for interacting with others and purchasing goods online, while still desiring to remain somewhat private in their interactions. As a result, it is important to be aware of these constraints, but also important to be aware of behavior that may be indicative of future buying habits and also factors that influence a user's purchases. This social network behavior information may be used to influence users by providing recommendations based on their online behavior and interactions with other users.

What is needed are methods and systems that are efficient at gathering relevant information about users, and also effective methods and systems that can utilize this information to influence a user to buy goods and services. As will be seen, the disclosure provides such methods and systems that can do this in an efficient and elegant manner.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 illustrates an example block diagram of a computing device;

FIG. 2 illustrates an example computer architecture that facilitates different implementations described herein;

FIG. 3 illustrates a flow chart of an example method according to one implementation;

FIG. 4 illustrates an example of social connections between users in a social neighborhood;

FIG. 5 illustrates a flow chart of an example method according to one implementation;

FIG. 6 illustrates a graphical representation of assigned strength of influence between a user and other users in a social neighborhood;

FIG. 7 illustrates the relationship between user scores of relationship strength and the mathematical distance of the model of FIG. 6;

FIG. 8 an example of social connections between users in a social neighborhood that changes over time;

FIG. 9 illustrates a flow chart of an example method according to one implementation;

FIG. 10A illustrates a schematic example illustrating a path between two users in a social network;

FIG. 10B illustrates a schematic example illustrating a path between two users in a changing social network;

FIG. 11 illustrates an implementation of a method and system for filtering connections in a social neighborhood;

FIG. 12A illustrates a non-geometrical graphic representation of connections in a social neighborhood;

FIG. 12B illustrates a non-geometrical graphic representation of connections in a social neighborhood;

FIG. 13A illustrates a graphic representation of the strength of the connections in a social neighborhood; and

FIG. 13B illustrates a graphic representation of the strength of the connections in a social neighborhood.

### DETAILED DESCRIPTION

The present disclosure extends to methods, systems, and computer program products for determining and building social neighborhoods based on user provided information and other related information from the user's activity and behavior on social networks. In the following description of the present disclosure, reference is made to the accompanying drawings, which form a part hereof, and in which is shown by way of illustration specific implementations in which the disclosure is may be practiced. It is understood that other implementations may be utilized and structural changes may be made without departing from the scope of the present disclosure.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS), and deployment models (e.g., private cloud, community cloud, public cloud, hybrid cloud, or any suitable service type model now known to those of ordinary skill in the field, or later discovered). Databases and servers described with respect to the present disclosure can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

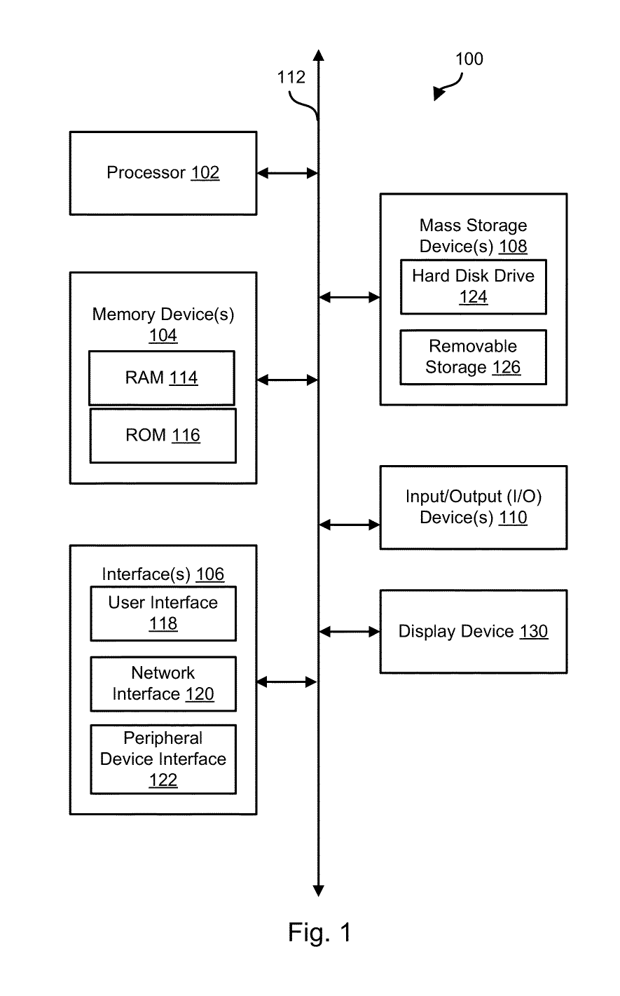

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid-state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 may include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, or any suitable user interface now known to those of ordinary skill in the field, or later discovered), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

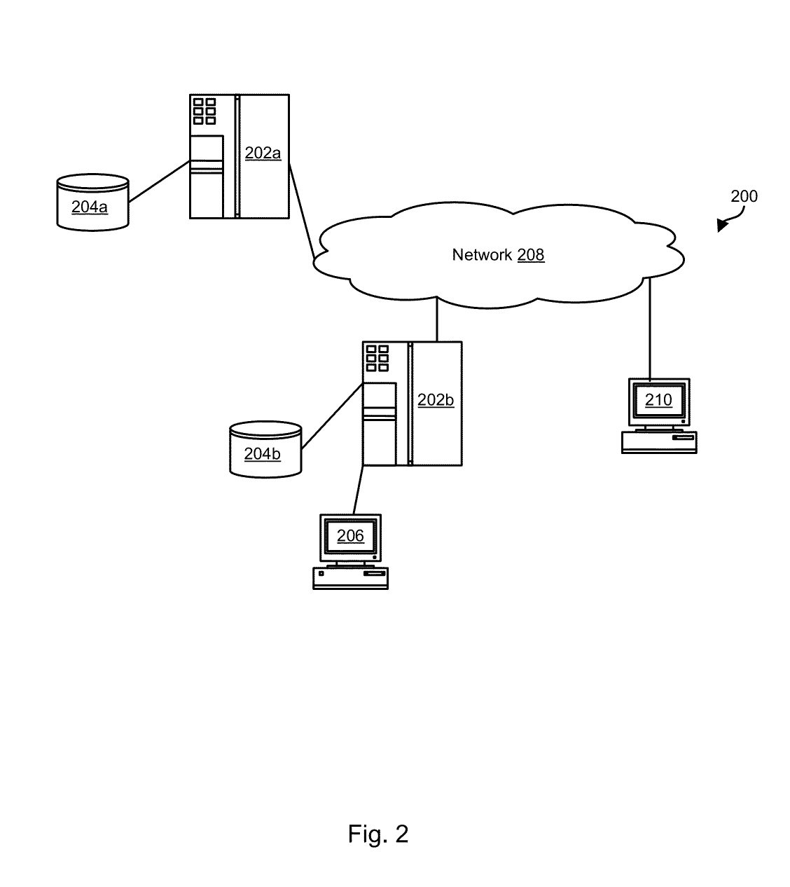

FIG. 2 illustrates an example of a computing environment 200 suitable for implementing the methods disclosed herein. In some implementations, a server 202a provides access to a database 204a in data communication therewith. The database 204a may store social media information such as a user profile as well as a list of other user profiles of friends and associates associated with the user profile. The database 204a may additionally store postings made by the user associated with the user profile. The social media information hosted by the database 204a may correspond to social media such as Facebook, Twitter, Foursquare, LinkedIn, or the like. The server 202a may provide access to the database 204a to users associated with the user profiles and/or to others. For example, the server 202a may implement a web server for receiving requests for data stored in the database 204a and formatting requested information into web pages. The web server may additionally be operable to receive information and store the information in the database 204a.

A server 202b may be associated with a merchant or by another entity providing gift recommendation services. The server 202b may be in data communication with a database 204b. The database 204b may store information regarding various products. In particular, information for a product may include a name, description, categorization, reviews, comments, price, past transaction data, and the like. The server 202b may analyze this data as well as data retrieved from the database 204a in order to perform methods as described herein. An operator may access the server 202b by means of a workstation 206, that may be embodied as any general purpose computer, tablet computer, smart phone, or the like.

The server 202a and server 202b may communicate with one another over a network 208 such as the Internet or some other local area network (LAN), wide area network (WAN), virtual private network (VPN), or other network. A user may access data and functionality provided by the servers 202a, 202b by means of a workstation 210 in data communication with the network 208. The workstation 210 may be embodied as a general purpose computer, tablet computer, smart phone or the like. For example, the workstation 210 may host a web browser for requesting web pages, displaying web pages, and receiving user interaction with web pages, and performing other functionality of a web browser. The workstation 210, workstation 206, servers 202a-202b, and databases 204a, 204b may have some or all of the attributes of the computing device 100.

In an implementation, social network information may be maintained in a computer database engine such as MySQL, comprising nodes and edges such that each node represents a user or an organization in the network and each edge represents a known direct connection between two nodes. One difficult aspect of analysis of social networks is that they are dynamic, especially in terms of continually adding more connections between users over time. There presumably exists an overall “social network”, for example, for all users in the U.S. (or worldwide) at a given moment. The disclosure provides a means to model this overall network efficiently; however, the known set of social connections at any instant may be very much incomplete due to users thus leaving most of their personal connections out of a database) and to users having incomplete sets of connections. Many methods of analyzing social networks are very sensitive to these types of changes.

The economic value of the network analysis of the disclosure, described herein, is great. One example is that the method describes influence groups of people who share enough similarity that they are apt to share many interests, including interest in marketed goods and services. Thus a user's interest in new music might be evaluated by knowing the interests of other users in the same influence cluster or neighborhood, whether they are closely connected to that user or not. Increasingly, the economic value of social networks lies in exactly this sort of recommendation engine capability. The disclosure provides a completely new method for providing such a recommendation engine based on the novel aspects, which include merged networks into a meta-network, asymmetric edge distances, neighborhood specification of direct influence groups, and clustering that is insensitive to the fact that the known social network may always be incomplete.

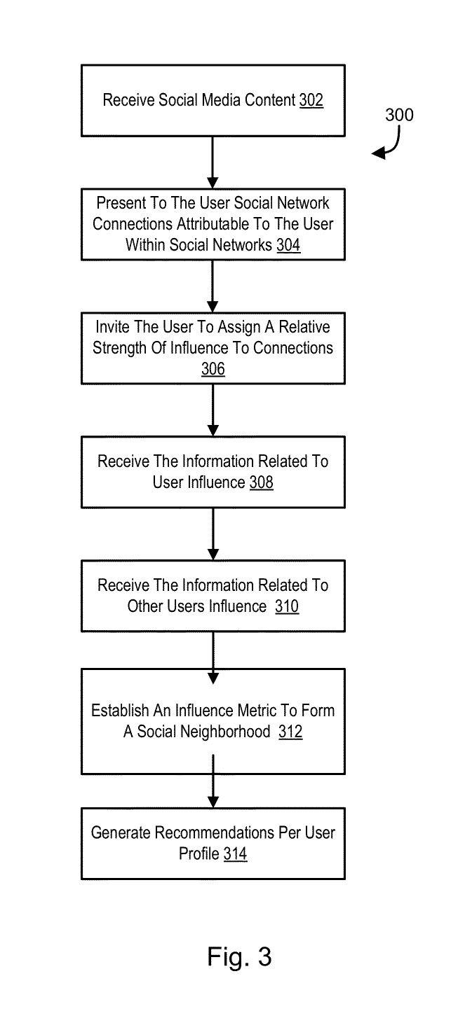

With reference primarily to FIG. 3, an implementation of a method for determining a social neighborhood will be discussed. FIG. 1 and FIG. 2 may be referenced secondarily during the discussion in order to provide hardware support for the implementation. A number of attributes described within social networks may be stored in a database, associated with each user (also referred to herein as nodes) and strength of influence (also referred to herein as edges or distances). In and implementation, nodes may comprise attributes that include but are not limited to: a unique identifier assigned such as a user's name, address and/or other items of information; unique identifiers for the node in each external social network containing the node, and statistical summaries of the node's network.

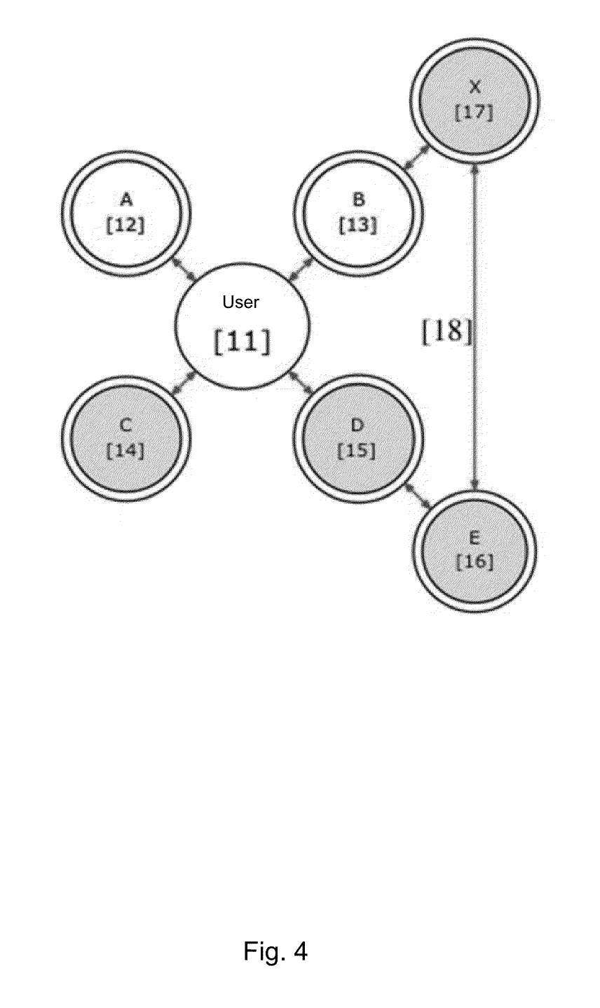

In an implementation, edges (18 of FIG. 4) may comprise attributes that include but are not limited to the unique identifiers of the two nodes that are connected by the edge, the source of the node's information (i.e. the external social network), the assigned social influence from the first node to the second node, and the assigned social influence from the second node to the first node, and statistical summaries of the edge's contribution to the network.

It should be noted that the social media content may include content generated by a user over time such as Facebook™ postings, Twitter™ tweets, Foursquare™ check ins, LinkedIn™ updates, or the like. The social media content may be distinguished from other social media data associated with a user, such as the user's profile for a given social media site and the user's connections to friends, family, and other acquaintances. In addition to social media content being accessed and stored in the system, other information can be utilized by the implementations of the method and the methods and apparatus shown in the figures including the system 100 and computing environment 200 or their equivalent, including but not limited to the actual purchase histories of friends, families, and other acquaintances. It should be noted that in addition to any social networking sites now known or later used that may accommodate the principles of the present disclosure, including but not limited to Facebook™, Twitter™, Foursquare™, LinkedIn™ or any suitable social networking cite, email address books and the like may be used to establish connections to a user. Furthermore, physical traditional mail information, such as United States Postal Service style address books, may be used by a system to establish connections for a user because at least a name and physical address is known for the other users. The system 100 and computing environment 200 as implemented according to the disclosure herein, can thereby be used to build a record of purchases made by a user's acquaintances, which can then be used as an indication of what the user may be inclined to purchase.

Accordingly, the method 300 may include receiving 302 social media content into a system and stored in memory. The social media content may include any type of behavior or actions made by a user, or other users within a social media site. Behavior and actions that may be of value in defining social neighborhoods may be, for example: connections to other users, posts in the form of texts, preferences shown by likes or dislikes, connections to non-directly connected other users (friends of friends), product commentary by various users, places visited as shown by checking in functionality within the various social media sites. The above mentioned examples are not intended to be limiting, and it is intended that any data generated by socially relevant sites is included within the scope of this disclosure. In an implementation, a user may be able to designate which social media sites that may be desirable to obtain information from, or the sites may be automatically selected by the method 300.

At 304, the social media content may be presented to a user for assessment by the user. For example, a user may be presented with a list of all of her social connections from her social media sites. In such an example the user may wish to select all of the available connections, or may wish to limit the selection to only a certain number of connections. The selection process by the user may be accomplished through any commonly known means such as, for example, mouse clicks, keyboarding, touch screen, or any suitable user input device now known to those of ordinary skill in the field, or later discovered, through a user interface on the user's computer. The selection may then be stored in computer readable memory for use by the method 300.

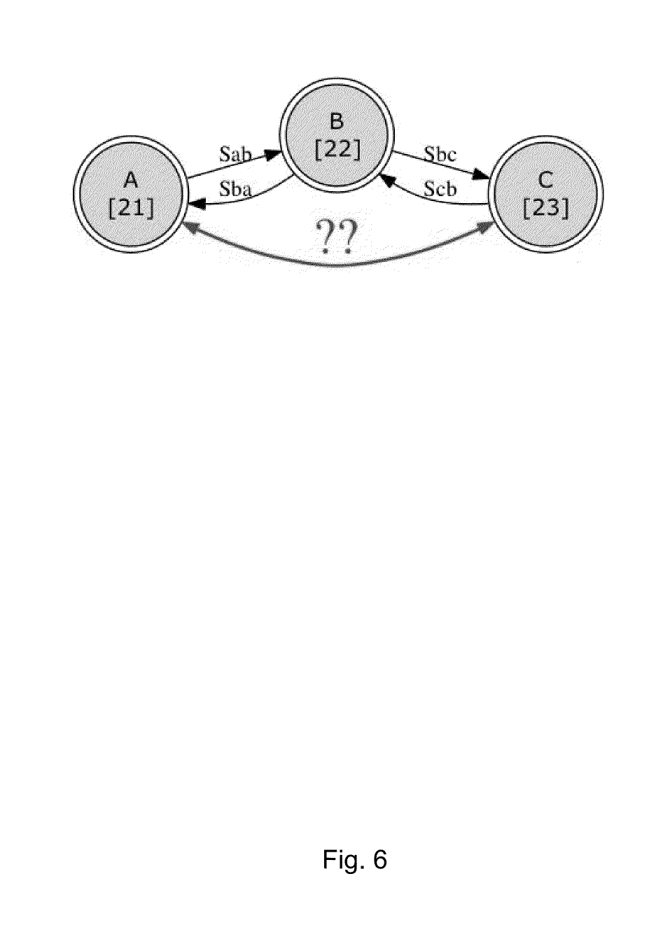

At 306, a user may be asked to assign a strength of influence (for example, a numerical value as discussed in more detail below in connection with FIGS. 6-7, 11, 13A, and 13B) for each of the connections received from the social networks. The assigning process by the user may be accomplished through any commonly known means such as, for example, mouse clicks, keyboarding, touch screen, or any suitable user input device now known to those of ordinary skill in the field, or later discovered, through a user interface on the user's computer. The strength of influence assignments may then be stored in computer readable memory for use by the method 300. In an implementation, the method 300 will receive user influence 308 information (data) by asking the user to assign a strength of influence for a connection that represents the user's influence over an other user. Likewise, the method 300 will receive user influence 310 information (data) by asking the user to assign a strength of influence for a connection that represents the influence that an other user may have over the user herself. At 312 the strength of influence information may be recorded into memory as an influence metric. Influence metrics may be discussed in the terms of distance, even though an actual distance may not exist between the points of social data used in the method. In other words the terms “social distance” and “distance” as used herein, is more figurative than actual.

At 314, a list of recommendations may be created for the user base on his social neighborhood and the behavior of others within the social neighborhood. For example, if influential users of the neighborhood are purchasing and talking about certain goods, it is likely that the user may desire to purchase those same goods. As such, a timely recommendation from a commonly used retailer of goods would prove beneficial to both the retailer and the user.

FIG. 4 depicts a fragment of an overall social network, in which a user (“User” [11]) belongs to two separate social networks, with other users from one network indicated by white filled circles (namely users “A”[12], “B”[13]”) and users from another social network indicated by grey filled circles (namely “C”[14], “D”[15], “E”[16] and “X”[17]. In our disclosure, the two social networks are joined into a single overall network. The figure indicates which users are directly connected, i.e. who know each other as indicated in the social network, by arrowed lines. An other user X [17] is, like the user, is a user of both social networks and has a connection to E in one and to B in the other. In this example, if each connection represents the same distance or strength between nodes, the shortest path from the user to X is the user to B to X, which may be indicated in terms of distance for the strength of influence value in the metric. The influence values may be converted to distances by a transformation that may be approximately equal to −log 10(S/10+0.01), where the term in parentheses is used as an estimate of the probability of a message being transmitted across the connection.

A user of the disclosure can explore his meta-network in a number of ways, without limitation to a small number of connections that may link him to another user. Among the interactive exploration methods, a user can modify this network, such as shown in FIG. 4, by removing nodes to find alternate paths of connection to another user.

In an implementation, a user may further specify the influence values, and thereby modify the social network distances, to other nodes, in separate contexts such as one for work, one for recreation, and so on, leading to a separate analysis of the social network for each different context.

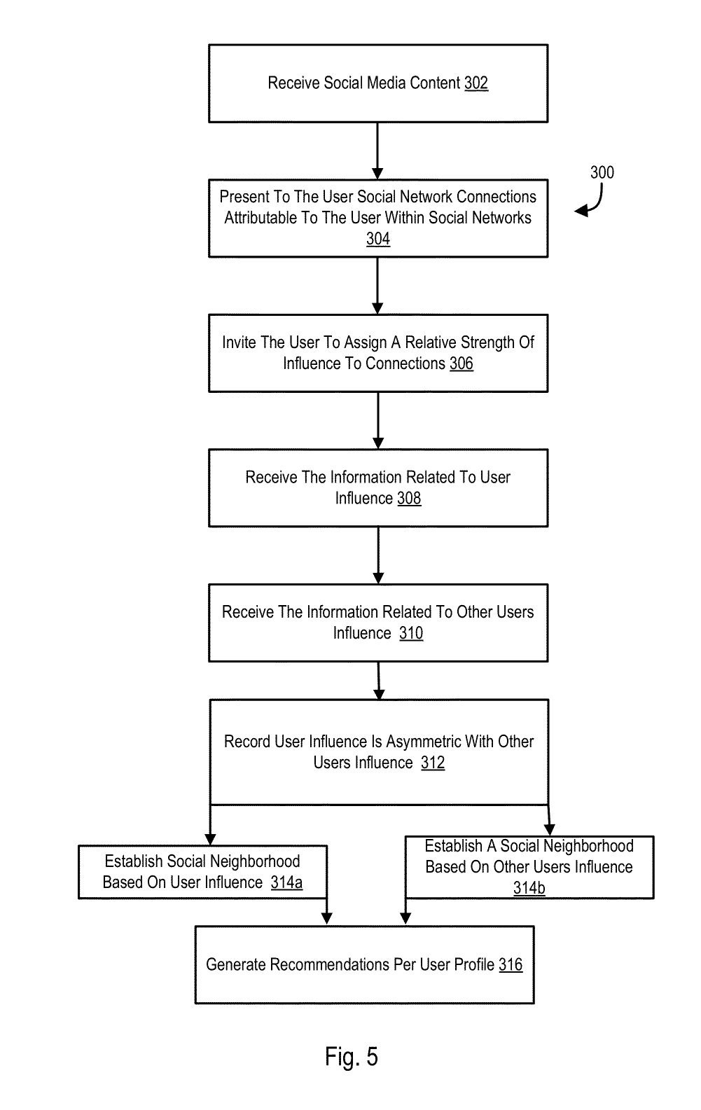

With reference primarily to FIG. 5, an implementation of a method for determining a social neighborhood wherein social connections are asymmetric will be discussed. Accordingly, the method 500 may include receiving 502 social media content into a system and storing in memory. The social media content may include any type of behavior or actions made by a user, or other users within a social media site. Behavior and actions that may be of value in defining social neighborhoods may be, for example: connections to other users, posts in the form of texts, preferences shown by likes or dislikes, connections to non-directly connected other users (friends of friends), product commentary by various users, places visited as shown by checking in functionality within the various social media sites. The above mentioned examples are not intended to be limiting, and it is intended that any data generated by socially relevant sites is included within the scope of this disclosure. In an implementation, a user may be able to designate which social media sites that may be desirable to obtain information there from, or the sites may be automatically selected by the method 500. Social connection may be linked together to form paths that may include both in-network and out-of-network users.

At 504, the social media content may be presented to a user for assessment by the user. For example, a user may be presented with a list of all of her social connections from her social media sites. In such an example the user may wish to select all of the available connections, or may wish to limit the selection to only a certain number of connections. The selection process by the user may be accomplished through any commonly known means such as, for example, mouse clicks, keyboarding, touch screen, and the like, through a user interface on the user's computer The selection may then be stored in computer readable memory for use by the method 500.

At 506, a user may be asked to assign a strength of influence for each of the connections received from the social networks. The assigning process by the user may be accomplished through any commonly known means such as, for example, mouse clicks, keyboarding, touch screen, or any suitable user input device now known to those of ordinary skill in the field, or later discovered, through a user interface on the user's computer. The strength of influence assignments may then be stored in computer readable memory for use by the method 500. In an implementation, the method 500 will receive user influence 508 information (data) by asking the user to assign a strength of influence for a connection that represents the user's influence over an other user. Likewise, the method 500 will receive user influence 510 information (data) by asking the user to assign a strength of influence for a connection that represents the influence that an other user may have over the user herself. A user may be able to assign differing or asymmetric strengths of influence depending asymmetric relationships are common, such as between an employee and her supervisor in which suggestions from the supervisor to employee are more likely to be adopted than suggestions from employee to supervisor. At 512 the asymmetric strength of influence information may be recorded into memory as an influence metric. Influence metrics may be discussed in the terms of distance, even though an actual distance may not exist between the points of social data used in the method.

At 514a, a social network may be determined based on the influence metrics that the user has over other users by analyzing the social distances between users based on the strength of influence between a plurality of users, as discussed in further detail below. Likewise at 514b, a social network may be determined based on the influence metrics that other users have over the user by analyzing the social distances between users based on the strength of influence between a plurality of users. Like in a real-life, much can be learned about an individual by studying the connections that individual has with other users of its social networks, and a construct of a social neighborhood can be formed.

At 516, a list of recommendations may be created for the user based on his social neighborhood and the behavior of others within the social neighborhood. For example, if influential users of the neighborhood are purchasing and talking about certain goods, it is likely that the user may desire to purchase those same goods. As such, a timely recommendation from a commonly used retailer of goods would prove beneficial to both the retailer and the user.

FIG. 6 is a schematic depicting an asymmetric strength of influence between a user, an intermediate user, and an other user. Asymmetric relationships are common, such as between an employee and her supervisor in which suggestions from the supervisor to employee are more likely to be adopted than suggestions from employee to supervisor. In an implementation, a meaningful measure of such an asymmetric connection is an inverse relationship. As can be seen in the figure, the connection between A [21] and B[22] can be considered as having two influence strengths within the connection. The first influence strength is influence that the behavior and recommendations of A[22] has over B[23], shown as Sab in the figure. The second influence strength is the influence that the behavior and recommendations of B[23] has over A[22], expressed as Sba in the figure. It should be noted, the Sab has a different value as Sba such that the relationship between A and B is asymmetric. Such reasoning, can be extrapolated between a plurality of users, such that a social distance or strength of influence can be determined for A[21] to C[23] and represented in the figure as Sab+Sbc and Scb+Sba.

In an implementation, the effective social distance/strength of influence (shown as arrowed line “??’) from A to C is a combination of the distance from A to B and the distance from B to C. In an implementation based on information theory, a meaningful measure of the link from A to C may be in fact the logarithm of the product of the inverse of the probability A-to-B with B-to-C measures. Logarithms of inverse probability add, in terms of information theory, and such values may be used in terms of distance D for constructing a social neighborhood as discussed above:

D=Σ−log(Probability of connection being made)

Additionally, within an implementation, a user may specify for each connection a strength of influence value on a scale S ranging from 0 (very low value connection) through 10 (very high value connection), as for example user B in FIG. 2 can specify the influence Sba to user A and Sbc to user C. In an implementation, a default value such as S=5 may be assigned when the user does not specify a value in order to provide influence values for every user.

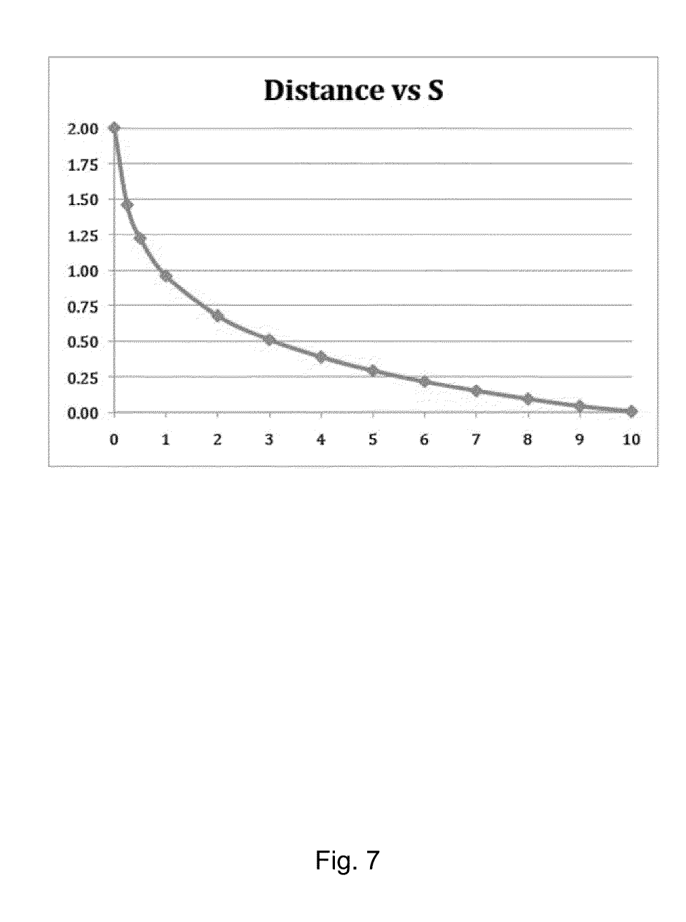

FIG. 7 shows a graph of the Distance between two nodes (users in the social network) as a function of the strength of influence score assigned by a user of our disclosure. In an implementation of the methods of the disclosure, a score of 10 represents the highest influence and most solid connections, with a score of 0 representing a distant connection of much less value. The equation used provides a distance of 2 at a score of 0 and a distance of just above 0 for the highest score of 10, with even integer values also shown on the graph. As can be seen by the plotted values in the graph, influence between users of a social neighborhood can be modeled to follow a classic logarithmic curve.

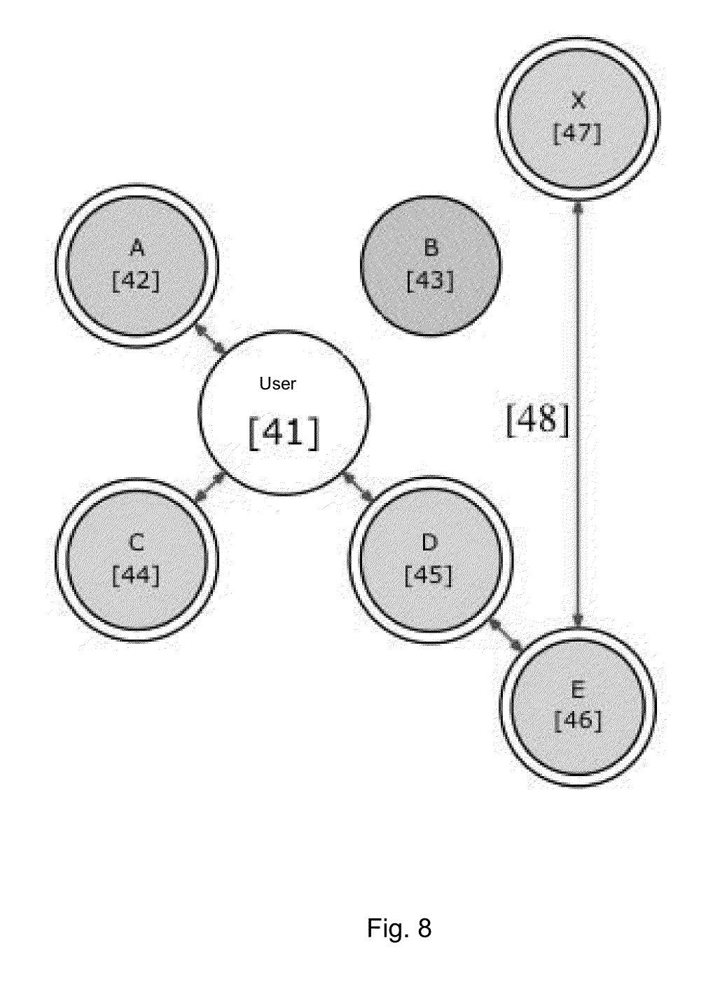

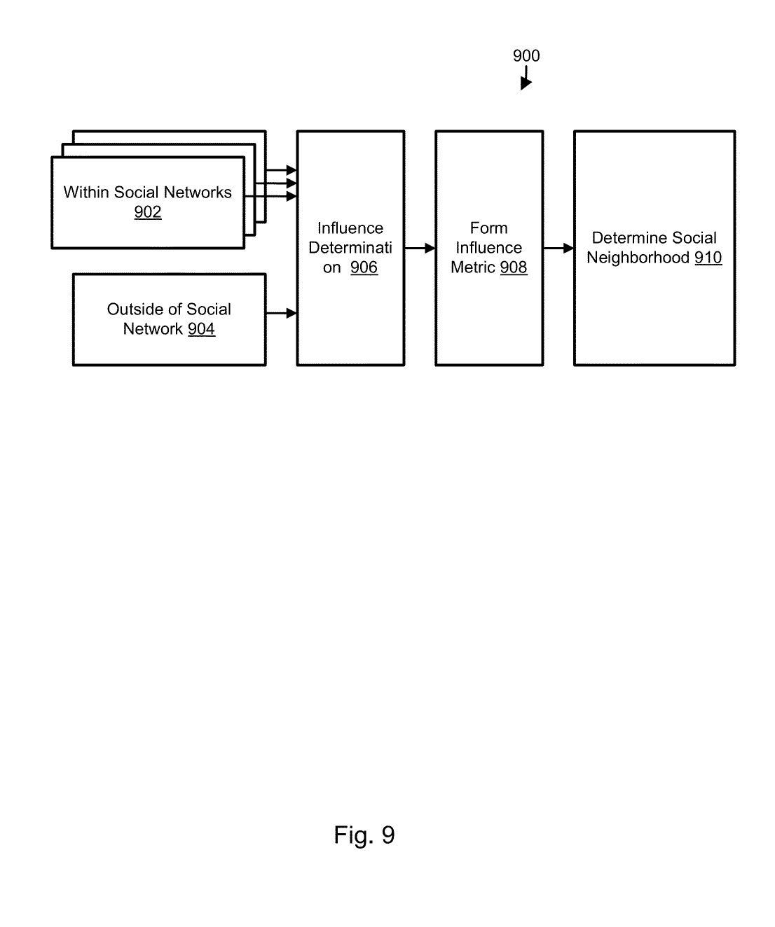

FIG. 8 corresponds to a change in the partial social network depicted in FIG. 6, in which the user has elected to remove user B from evaluation of the network. The shortest path from a user to an other user X is now changed from that of FIG. 6 (user->B->X) to the only remaining path (user->D->E->X). Such a change may model real world conditions where a user of a social neighborhood may be removed by such conditions as: withdrawing from a social network, death, end of friendship, or any other change of social circumstances that would remove social connections between users. Users may make these types of temporary changes interactively, to further explore and refine the overall social neighborhood of which they are a part. Such refining may be performed manually by a user, or automatically by a method and system in various implementations. Such an implementation of a method for refining a social neighborhood, and selecting other users from inside and outside social networks is shown in FIG. 9.

Referring now to FIG. 9, an implementation of a method for determining a social neighborhood having other users from both within and outside the social network of the user. A method 900 for determining a social network for a user may comprise a receiving process 902 of obtaining social network information/data for other users who are user of the user's social networks. The method may further comprise a receiving process 904 of obtaining social network information/data for other users that are not users of the user's social networks. As discussed above, other users may be selected by the user. It should be noted that the user may select other users from outside of her social network, such as for example, popular other users that may be celebrities that tweet or post influential information that would be advantageous for recommendations to the user. At 906 the method 900 may determine the influence strength for the connections selected in processed 902 and 904. The influence determination 906 may be manually or automatically processed by the method 900 as discussed above, to form an influence metric in process 908. The method 900 may then determine 910 a social neighborhood for a user that comprises influences by the behaviors of other users that are both inside and outside of the user's social networks. In should also me noted that a user may remove someone from its social network (as shown in FIG. 8) but may still desire that user to have influence on the user's social neighborhood. The method 900 would allow such a circumstance.

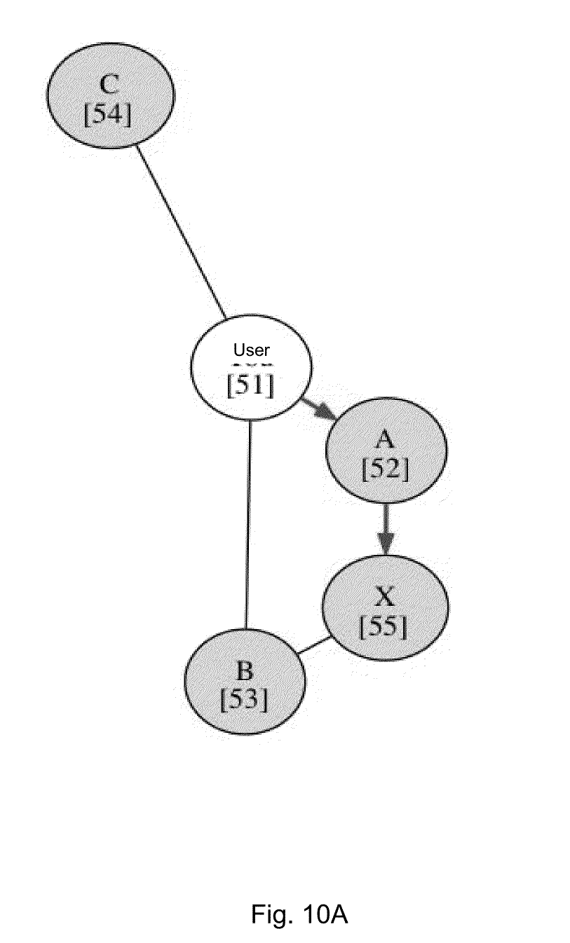

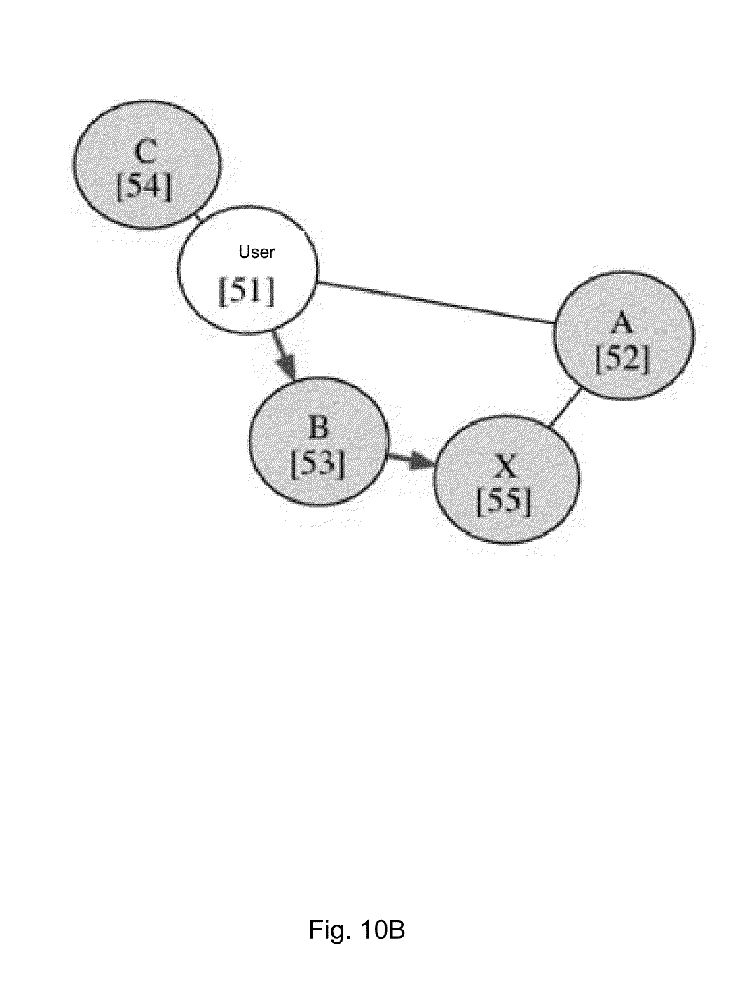

FIG. 10 illustrates a schematic of a social network in which the lengths of the lines connecting users user, A, B, C and X are proportional to the relative strength of influence between the connected users and change over time. The same social neighborhood can have a different or asymmetric network of influence strengths. For example, FIG. 10A may indicate influence in a work context, such that the shortest (most influential) path from user to X is (user->A->X), while FIG. 10B illustrates influence among the same chain of users in a political context, with shortest (most influential) path to X now being (user->B->X) as indicated by the arrows. Thus, as seen by comparing FIG. 10A to FIG. 10B, the evaluation of network structure for influence strength can also depend on the context being considered because different users of a social neighborhood can have different levels of influence depending on the subject matter of the recommendation. For example, if a user of the social neighborhood is known by the user to be knowledgeable about cars, then that user would have a strong influence when recommending auto related products.

In all of the figures and discussions, it is possible in to interchange any of the users in a social neighborhood with companies or other organizations, thus permitting social influence to be considered for such things as, places of worship, shared place of employment, clubs, and any other form of community that may exert social influence.

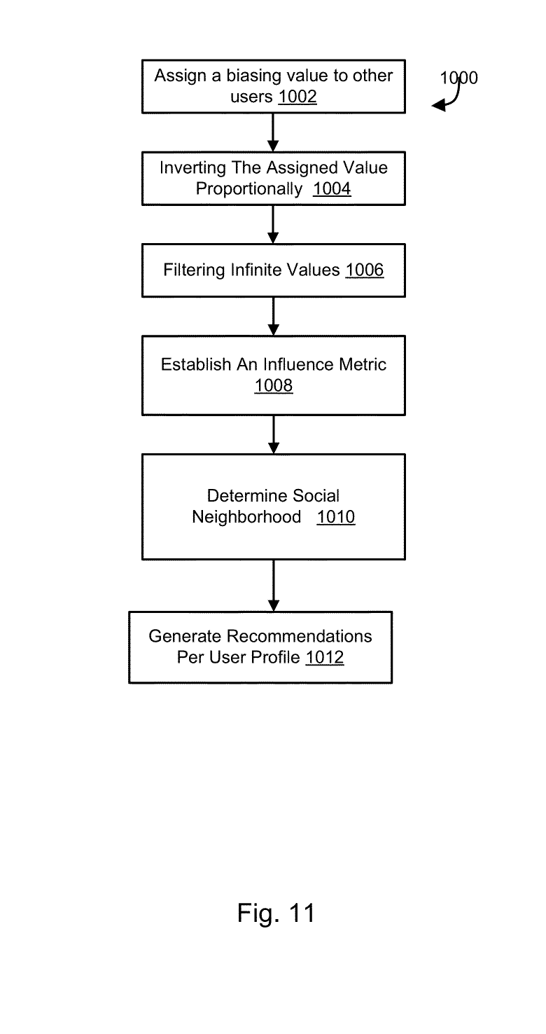

In an implementation illustrated in FIG. 11, the discloser allows a user to adjust and filter a neighborhood determination to reflect a more desired outcome. It is possible to assign 1002 a value to all other users (nodes), such that the shortest (most influential) path may be biased toward nodes with high value and strong influence. The method 1000 may be programmed to ignore other users that have been assigned zero value of influence by inverting the assigned value proportionally 1004 such that the value becomes infinite and therefore too great for any calculation of a shortest path. Doing so may be a more general way of filtering out infinite values 1006 such that by assigning a value of 0.0 to an other user would result in that other user having no influence over the user. In other words, when a user assigns zero value to strength of influence to an other user, the influence of the other user can be filtered out of any neighborhood determination by inversing the zero such that it becomes an infinite value (infinite distance meaning nearly zero influence) and then removing it from the neighborhood determination. The inverted values may then be established as influence metrics 1008 as discussed above. The method 1000 may further determine a social neighborhood 1010 and generate recommendations 1012 for the user based on the user's social neighborhood.

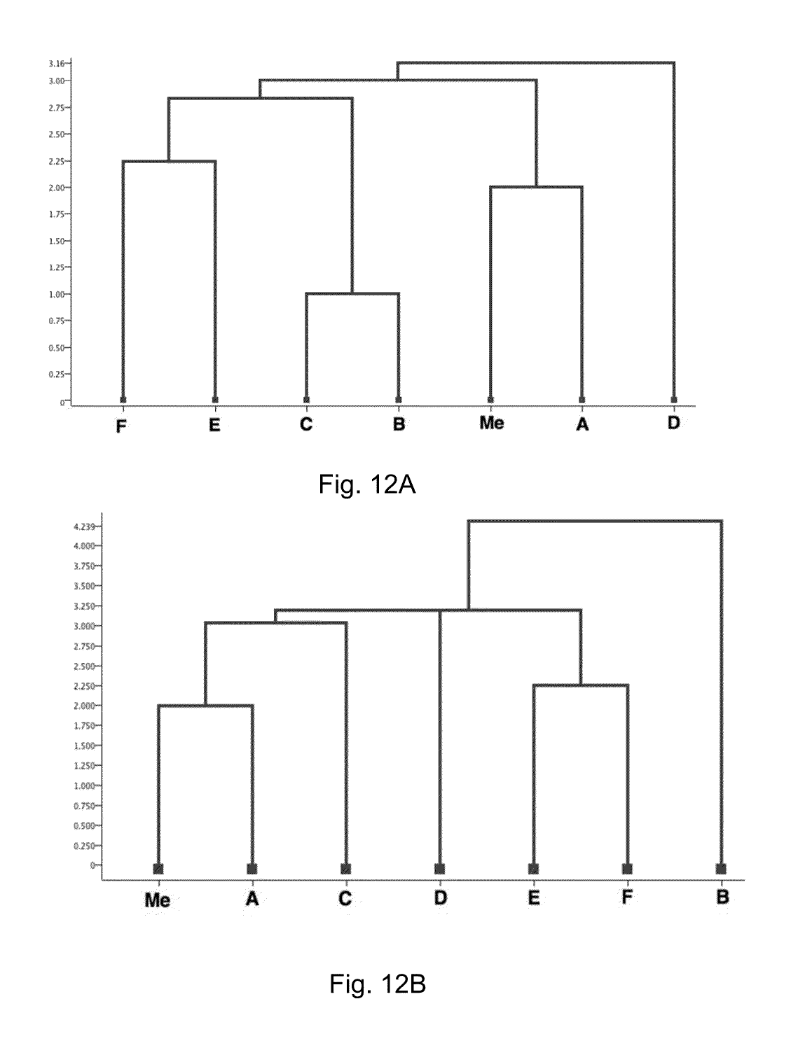

FIG. 12A and FIG. 12B illustrate non-geometric forms of a social neighborhood determination that may be used for making recommendations in implementations of the present disclosure. It may typically not be possible to represent even a small social network in a two-dimensional graph for which edge lengths correspond to distances that represent strength of influence. In this simple example, distances of connected edges are computed from the two dimensional coordinates of the nodes user, A, B, C, D, E and F. The social distance between points not directly connected by a line is the shortest path following lines.

In general, furthermore, it is possible to have very small distances (for example in FIG. 12A) for Me->A and for A->C such that the shortest path from Me->C would be Me->A->C, even though Me is directly connected to C. This happens if the sum of the edge distances is less than the single edge distance of the direct connection. In the geometric sense, of course, the shortest distance between two points is a straight line; this indicates the non-geometric nature of social networks. The unusual behavior does correspond to social interactions, in which Me may know user C but have a very distant relationship connection, so that the best way to get a message to user C might well involve one or more intermediaries with very solid connections at each step.

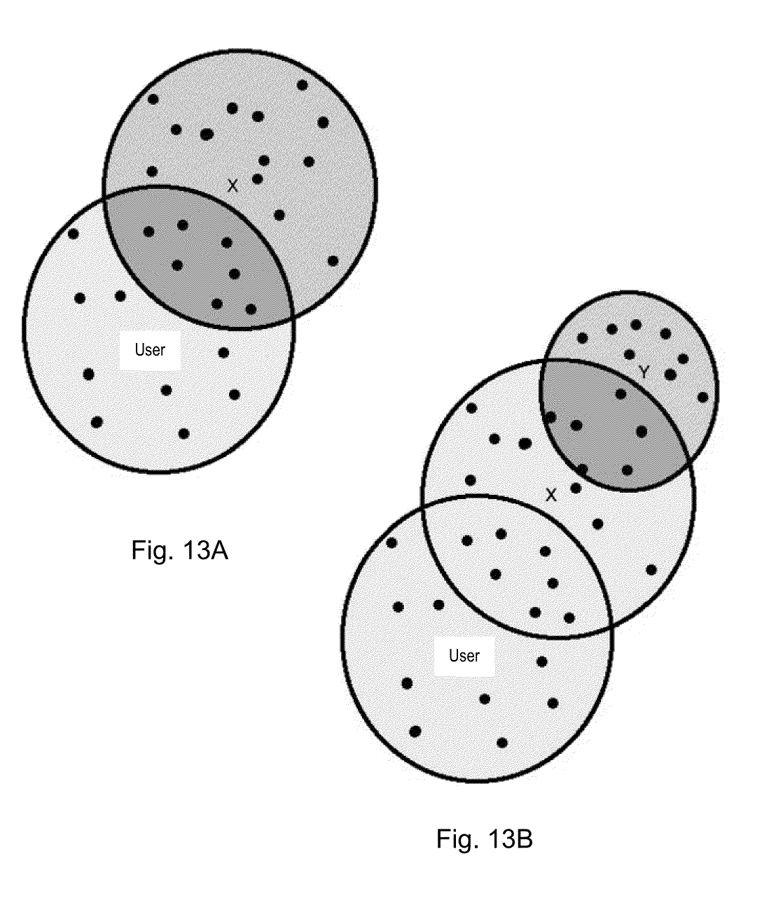

FIG. 13A and FIG. 13B illustrate schematics of a social network in which the network's shortest-path connections between user and other users (represented by dots) is not shown, but the distances of dots from user is proportional to the shortest path distance from user to the other user. This is a key element of our disclosure, namely that important analysis of the social network is performed on the (non-geometric) distance matrix without further regard for the underlying network connections themselves to yield a set of “neighbors” for each user. The relationship of another user, X, is introduced with the same construction. Circles indicate the “neighborhood radius” for user and X that is considered to be the limit of meaningful connection. The area of overlap, containing users within the influence neighborhood radius of both user and other user X, is a measure of the influence between user and X.

FIG. 13A further shows a step in clustering, based on the neighbors of users, to indicate how the cluster consisting of both User and X may overlap with an influence neighborhood of user Y to form an additional cluster of all three users plus those users within the neighborhood radius of any of the three. In this step, it is clear that some users of the influence neighborhood associated with User are rather distant from some users of the influence neighborhood of user Y. Nevertheless, they share a large influence cluster. This figure represents a valuable aspect of the disclosure. In particular, we see that the influence group of a user may be influenced by users not closely connected in the social network. (It can be shown mathematically that all users in such clusters are connected by one or more paths in the underlying network.)

In an implementation, the method and system may replace the hierarchical clustering based on influence neighborhoods with fuzzy cluster analysis, or replacing the idea of a neighborhood radius to place users inside or outside the influence neighborhood with a fuzzy membership that is high at small distances and effectively zero at larger distances. The representation of such influence groups can be made graphically, as has been done with clusters of chemicals (see for example Clark et al, “Visualizing substructural fingerprints”, J. Mol. Graph. Model. 2000, vol 18 pp 404-411).

In an implementation, the operation of the disclosed methods and systems provide useful neighborhood determinations by: First, a context is selected that defines the specific social network involved (work related, social, any other form of community that may exert social influence); Second, a neighborhood distance is selected such that for each user any other user within that distance is considered an influence neighbor of the user.

As used herein, distances may be the shortest path distances, with direct connection distances defined by the assigned influence scores S as illustrated and discussed above with reference to FIG. 6, and connected paths with intervening nodes assigned distances that are the sum of the (direction dependent) distances of the individual directly connected edges.

For each user, the set of other users within a predetermined distance is obtained and stored for efficient processing. In an implementation, the form is that of a run-length-encoded compression of a bitset; the bitset contains a 1 for every user who is an influence neighbor and a 0 for every other person. The bitset has as many bits as there are people in the network. Since no user knows more than half of all people, the bitsets may be sparse, consisting mostly of 0 bits.

These bitsets, one for each user in the network, represent separate clusters. There may be substantial overlap among users in the users to whom they are connected (equivalently, to the bits set to “1” in their bitsets). The bitsets maybe affected by the asymmetry of the connection distances: user A may include user B in his neighborhood while user B may not include user A in her neighborhood if she has specified a high distance to user A. The similarity between any pair of users can be evaluated by this overlap. In an implementation the measure of such overlap may be: the number of shared users measured as the number of bits set to “1” in the intersection of their bitsets, when the overall network is sparse and such intersections are few, or the Tanimoto measure of similarity, which is measured as the number of “1” bits in the intersection of the two bitsets divided by the number of “1” bits in the intersection of the two bitsets. The Tanimoto index may be used and measures the fraction of overlap rather than the absolute count of overlap.

Bitsets may be then joined in a hierarchical fashion, such that:

the two clusters with highest similarity may be joined at each step;

the two clusters are then converted to a single cluster, as in FIG. 13A and FIG. 13B, and their bitsets may be set to the union of their separate bitsets.

This joining operation may continue until the similarities drop below a specified value, or until there is no overlap between the remaining clusters. In the latter case, the remaining clusters are effectively disjointed subnetworks in the sense that no user of any such cluster is within the neighborhood radius of any user of any other such cluster.

Therefore, the clustering thus derived is relatively insensitive to small changes in the underlying network and to small changes in the distance of directly connected nodes. It further represents a multi-tiered description of the overall social network which can be approximated with traditional sampling techniques of the individual user's bitsets if the size of the network becomes larger than is practical (note that analysis of the network in the direct sense is very sensitive to subsampling and to missing information, while subsampling of the full bites descriptions is not so.)

In an implementation where users are unable to provide full information about their networks, unique identifier codes of the nodes of a user's network may be stored with in a system, which assures that our disclosure can immediately associate a new user with her connections that are already users within our disclosure's implementation. For example, user A may provide the unique identifier codes of all his connections within one social network, which includes a code XXXXX that refers to an unknown user. If another user has linked to the same code XXXXX, the system may shows that the two users are linked to a same user (unknown but known to the users). At any point when the user with code XXXXX joins as a user of our disclosure, the identity becomes known to us and can be shared with our users. If user with code is a user of an additional social network in which he has code YYYYY, then the association is made between the two social networks, and our meta-network can connect two users whose connection spans the two separate social networks, as in FIG. 4.

Thus the disclosure provides a method and system for evaluating the structure of a social network in order to create a social neighborhood, which is robust to small changes within the social network, and which reveals important aspects of the influence among users of the network that are not easily identified by currently existing means.

It is to be understood by those skilled in the field that numerical value is only one non-limiting example of a “strength of influence,” or other strength designating attribute, that may be assigned, received, evaluated and presented within the methods and systems of the present disclosure. Other representative “strength of influence” value examples include a selection from a range of emotional feelings, or a selection from a range of impressions such as: competence of an other user, sociability of an other user, perceived consumer activity of an other user, or other suitable strength concepts, regardless of whether such strength concept can be further assessed mathematically, such as logarithmically.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for determining, by a social neighborhood server, a social neighborhood of a user, comprising:
receiving user information, by the social neighborhood server, related to social network connections to other users in the user's social network;
presenting to the user, by a user's computing device, social network connections attributable to the user based on the received user information;
inviting the user, by the social neighborhood server to the user's computing device, to assign a relative strength of influence of said other users on said user's behavior that the user attributes to individual social network connections presented to the user;
inviting the user, by the social neighborhood server to the user's computing device, to assign a relative strength of influence of said user on said other user's behavior that the user attributes to individual social network connections presented to the user
receiving the information related to the user influence;
establishing an influence metric to the individual social network connections that the user assigns a relative strength of influence thereto to determine a social neighborhood; and
generating recommendations based on the user's social connections and corresponding influence metrics.

2. A method according to claim 1, wherein the relative strength of influence of said user on said other user's behavior and the relative strength of influence of said other users on said user's behavior are asymmetric.

3. A method according to claim 2, further comprising establishing an asymmetric distance matrix to generate an influence network made up of other users who may influence user.

4. A method according to claim 3, further comprising generating recommendations for the user based on behaviors of those in the influence network.

5. A method according to claim 2, further comprising establishing an asymmetric distance matrix to generate an influence network made up of other users who may be influenced by user.

6. A method according to claim 4, further comprising generating recommendations for the other users based on behaviors of those in the influence network.

7. A method according to claim 1, wherein the social network connections presented to the user are within a users' existing social network.

8. A method according to claim 1, wherein the social network connections presented to the user are outside a users' existing social network.

9. A method according to claim 3, wherein the distance matrix is made up of values representing distances between the user and other users that are reachable by any set of edges.

10. A method according to claim 9, wherein the distance matrix is made up of values that are defined by the smallest number of edges that are needed to get from the user to the other user.
A method according to claim 10, further comprising generating recommendations for the other users based on the distance matrix made up of values that are defined by the smallest number of edges that are needed to get from the user to the other user.

11. A system for determining a social neighborhood of a user comprising one or more processors and one or more memory devices operably coupled to the one or more processors and storing executable and operational data, the executable and operational data effective to cause the one or more processors to:
receive user information, by a social neighborhood server, related to social network connections to other users in the user's social network;
present to the user, by a user's computing device, social network connections attributable to the user based on the received user information;
invite the user, by the social neighborhood server to the user's computing device, to assign a relative strength of influence of said other users on said user's behavior that the user attributes to individual social network connections presented to the user;
invite the user, by the social neighborhood server to the user's computing device, to assign a relative strength of influence of said user on said other user's behavior that the user attributes to individual social network connections presented to the user
receive the information related to the user influence;
establish an influence metric to the individual social network connections that the user assigns a relative strength of influence thereto to determine a social neighborhood; and
generate recommendations based on the user's social connections and corresponding influence metrics.

12. A system according to claim 11, wherein the relative strength of influence of said user on said other user's behavior and the relative strength of influence of said other users on said user's behavior are asymmetric.

13. A system according to claim 12, further comprising establishing an asymmetric distance matrix to generate an influence network made up of other users who may influence user.

14. A system according to claim 13, further comprising generating recommendations for the user based on behaviors of those in the influence network.

15. A system according to claim 12, further comprising establishing an asymmetric distance matrix to generate an influence network made up of other users who may be influenced by user.

16. A system according to claim 14, further comprising generating recommendations for the other users based on behaviors of those in the influence network.

17. A system according to claim 11, wherein the social network connections presented to the user are within a users' existing social network.

18. A system according to claim 11, wherein the social network connections presented to the user are outside a users' existing social network.

19. A system according to claim 13, wherein the distance matrix is made up of values representing distances between the user and other users that are reachable by any set of edges.

20. A system according to claim 19, wherein the distance matrix is made up of values that are defined by the smallest number of edges that are needed to get from the user to the other user.

21. A system according to claim 20, further comprising generating recommendations for the other users based on the distance matrix made up of values that are defined by the smallest number of edges that are needed to get from the user to the other user.

22. A system according to claim 19, wherein a set of edges used for determining values representing distances between the user and other users, passes through an intervening user disposed between the user and other user within the social neighborhood.
